(19) United States
(12) Patent Application Publication
(10) Pub. No.: US 2025/0010898 A1
(43) Pub. Date: Jan. 9, 2025

(54) SYSTEMS AND METHODS FOR LOWERING A CART IN A MODULAR GROW TOWER

(71) Applicant: Tavaci Technologies LLC, Alpine, UT (US)

(72) Inventors: Sean R. Peterson, Payson, UT (US); Johndavid Tueller, Orem, UT (US); Todd Garrett Tueller, Alpine, UT (US); Ryan Joseph Crawford, Salem, UT (US)

(21) Appl. No.: 18/765,059

(22) Filed: Jul. 5, 2024

Related U.S. Application Data
(60) Provisional application No. 63/512,138, filed on Jul. 6, 2023.
(60) Provisional application No. 63/512,129, filed on Jul. 6, 2023.

(51) Int. Cl. B62B 3/00; B62B 3/02

(52) U.S. Cl. CPC B62B 3/006; B62B 3/02

(57) ABSTRACT

The present disclosure presents systems and related methods for lowering a cart in a modular grow tower assembly. One such system comprise a plurality of body frames, each having multiple subframe supports arranged in parallel in a vertical direction, and a plurality of lift frames positioned at opposite ends of the body frames. The system further includes a plurality of carts, each cart comprising at least a plurality of wheels for traversing the subframe supports; a tray to support growing of crop material; or an engagement mechanism such that the carts remain in contact with adjacent carts as they traverse the subframe supports and become disengaged when the cart is moved vertically by a lowering lift mechanism. The system also includes a plurality of lowering lift mechanisms confined within the lift frames that are configured to pull, lower, and push one of the carts.

### CROSS-REFERENCE TO RELATED APPLICATION

This application claims priority to co-pending U.S. provisional application entitled, “Systems and Methods for Lowering a Cart in a Grow Pod,” having application No. 63/512,138, filed Jul. 6, 2023, and U.S. provisional application entitled, “Systems and Methods for Providing a Modular Grow Pod,” having application No. 63/512,129, filed Jul. 6, 2023, each of which is entirely incorporated herein by reference.

### TECHNICAL FIELD

Embodiments described herein generally relate to systems and methods for lowering a cart in a modular grow tower, and more particularly, to a plurality of lowering lift mechanisms for lowering a cart in a modular grow tower.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, pets, and livestock, other countries and future populations may not have enough farmland to provide the appropriate amount of crops for these purposes.

### SUMMARY

Embodiments of the present disclosure present systems and related methods for lowering a cart in a modular grow tower assembly. One such system comprises a plurality of body frames, each having multiple subframe supports arranged in parallel in a vertical direction; a plurality of lift frames positioned at opposite ends of the body frames; and a plurality of carts, each cart comprising at least one of the following features: a plurality of wheels for traversing the subframe supports; a tray to support growing of crop material; or an engagement mechanism such that the carts remain in contact with adjacent carts as they traverse the subframe supports and become disengaged when the cart is moved vertically by a lowering lift mechanism. Such a system can further includes a plurality of lowering lift mechanisms confined within the lift frames, each configured to pull one of the carts from a subframe support, lower the cart to a new subframe support, and push the cart onto the new subframe support, facilitating movement of the carts through the modular grow tower assembly.

Embodiments of the present disclosure also include a method comprising providing a modular grow tower assembly including a plurality of body frames and a plurality of lift frames, where each body frame includes multiple subframe supports arranged in parallel in a vertical direction; configuring a plurality of carts to traverse the subframe supports, each cart having a first end with at least one male engagement mechanism and a second end with at least one female engagement mechanism; and/or utilizing a plurality of lowering lift mechanisms within the lift frames to pull carts from the subframe supports of the body frames, lower the carts, and push the carts onto lower subframe supports.

Embodiments of the present disclosure also include a lowering lift mechanism for lowering a cart in a modular grow tower assembly. Such an apparatus comprises a receiving plate for engaging with the cart, including first and second arms located at opposite ends of the receiving plate; first and second receiving blocks located on the first and second arms, respectively, each receiving block including notches configured to engage male and female engagement mechanisms on the cart; an actuator configured to move the receiving plate between an extended position, where the first and second arms extend into subframe supports to engage the cart, and a retracted position, where the plate is within the lift frame; and a lifting mechanism configured to raise the cart above a bumper on the subframe support before pulling the cart into the lift frame and lowering the cart to align with a lower subframe support, then extending the receiving plate to push the cart onto the new subframe support.

In one or more aspects for modular grow tower systems and related methods and apparatuses, the carts move in serpentine movement through the modular grow tower assembly; the body frames and lift frames are connected using a fastening mechanisms and are configured or rearranged to adjust a size of the modular grow tower assembly; each cart includes wheels for supporting a cart; the engagement mechanism comprises a notch for secure engagement with a corresponding engagement mechanism of an adjacent cart; and/or the lowering lift mechanisms are synchronized to ensure that a cart is pulled from a subframe support before another cart is pushed onto the same subframe support.

In one or more aspects, such systems, methods, and/or apparatuses of the present disclosure can involve or comprise support stops located at the ends of the subframe supports, each support stop including a bumper to stop motion of the carts; a computing environment to monitor and control operations of the modular grow tower assembly, including a tower computing device configured to execute system synchronization and crop logic for managing the movement of carts and crop growth conditions; wherein the tower computing device is configured to control operation of the body frames, lift frames, and carts; raising the cart above a bumper located at the end of each subframe support before pulling the cart into the lift frame; introducing new carts onto the uppermost subframe support of a top row, pushing existing carts in a longitudinal direction through the body frames, and repeating the lowering process until the carts traverse in a serpentine path to a bottommost subframe support of a bottom row; sanitizing and seeding the carts with new crop material after harvesting; and/or receiving, by a tower computing device, grow recipes from a remote computing device and adjusting operation of the modular grow tower assembly accordingly.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts a partially exploded view of a modular grow tower assembly according to one or more embodiments described herein;

FIG. 2A depicts a body frame of the modular grow tower assembly of FIG. 1 according to one or more embodiments shown and described herein;

FIG. 2B depicts a support stop located on the body frame of FIG. 2 according to one or more embodiments shown and described herein;

FIG. 3 depicts a lift frame of the modular grow tower assembly of FIG. 1 according to one or more embodiments shown and described herein;

FIG. 4 depicts a perspective view of a cart for receiving crops and/or crop material in the modular grow tower assembly of FIG. 1 according to one or more embodiments described herein;

FIG. 5 depicts a lowering lift mechanism for lowering carts through the grow tower assembly of FIG. 1 according to one or more embodiments described herein;

FIG. 6 depicts a computing environment for providing a modular grow tower assembly according to one or more embodiments described herein; and

FIG. 7 depicts a modular grow tower computing device according to one or more embodiments described herein.

### DETAILED DESCRIPTION

Embodiments disclosed herein include systems and methods for lowering carts in a modular grow tower assembly. The modular grow tower may include a plurality of body frames and a plurality of lift frames, which may be configured such that the plurality of body frames are positioned between the plurality of lift frames. The body frames may include a plurality of subframe supports which are arranged parallel to one another in a vertical direction and configured to hold the carts. The lift frames may include a plurality of lowering lift mechanisms, which may be configured to pull carts from the subframe supports and lower the carts to a new subframe support. Once the cart has been lowered, the lowering lift mechanism may be configured to push the cart onto the new subframe support. The process of pulling a cart from a subframe support, lowering the cart, and pushing the cart onto a new subframe support may result in the carts following a moving path (e.g., serpentine moving path, circular moving path, curved or straight moving path, etc.) as the carts traverse the modular grow tower.

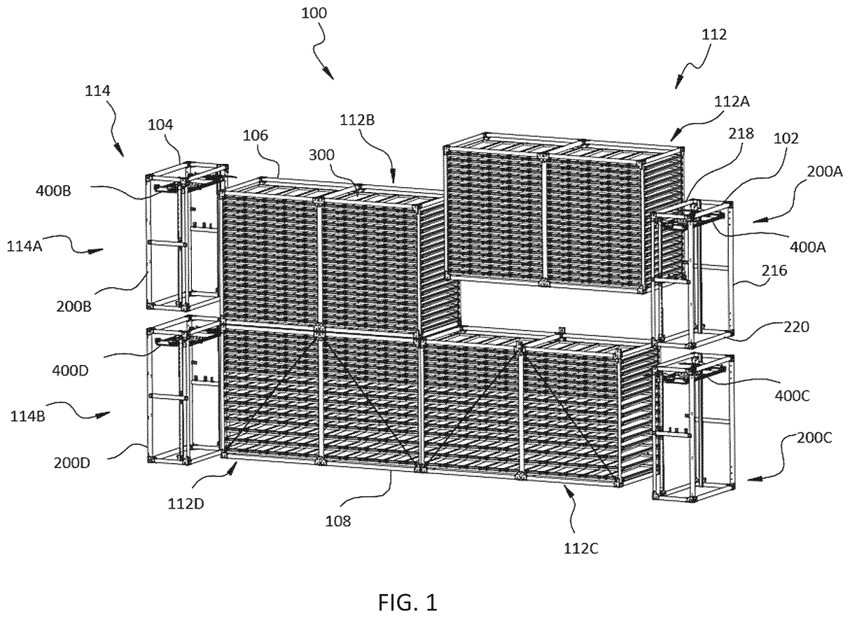

Referring now to FIG. 1, a modular grow tower assembly 100 is illustrated according to one or more embodiments described herein. The modular grow tower assembly 100 may generally include a first end 102, a second end 104 opposite the first end 102, a top end 106, and a bottom end 108 opposite the top end 106. As discussed herein, the size of the modular grow tower assembly 100 may be customizable based on user requirements and the type of crop to be grown within the modular grow tower assembly 100. Crops and crop materials may include traditional agricultural materials, for example, seeds and plants, as well as non-traditional materials, for example, eggs, algae, insects, insect larvae, fungi, other kinds of organic material, and/or the like. The modular grow tower assembly 100 comprises a plurality of lift frames 200A-200D (collectively referred to as 200) at the first end 102 and the second end 104, and a plurality of body frames 112A-112D (collectively referred to as 112) are positioned between the plurality of lift frames 200 at the first end 102 and the second end 104.

The plurality of lift frames 200 and the plurality of body frames 112 are arranged in a plurality of rows 114A, 114B (collectively referred to as 114). Accordingly, each row 114 includes a lift frame 200 at a first end 102 and at a second end 104, and a plurality of body frames 112 provided between each of the lift frames 200. However, it should be appreciated that only a single body frame 112 may be provided in each row 114. The rows 114 extend in a longitudinal direction and are stacked on top of one another in a vertical direction. As referred to herein, the rows 114 include a top row 114A and the bottom row 114B. Thus, this example of the present modular grow tower assembly 100 comprises four body frames 112A, 112B, 112C, 112D and four lift frames 200A, 200B, 200C, 200D. However, it should be appreciated that other configurations of the modular grow tower assembly 100 are contemplated as being within the scope of the present application.

Referring still to FIG. 1, the body frames 112 and the lift frames 200 may be attached to adjacent lift frames 200 and/or body frames 112. Accordingly, the lift frames 200 and the body frames 112 may be connected by utilizing any suitable fastening mechanism. Similarly, the lift frames 200 and the body frames 112 may be disconnected from one another to be rearranged as necessary to adjust the size of the modular grow tower assembly 100, i.e., the number of rows 114 and the number of body frames 112 within each row 114.

In various embodiments, the modular grow tower assembly and constituent lift frames and body frames can comprises a variety of materials, such as, but not limited to, aluminum alloys, titanium alloys, carbon fiber reinforced polymer (CFRP), glass fiber reinforced polymer (GFRP), high-strength low-alloy (HSLA) steel, stainless steel, bamboo, composite materials (hybrid), engineered wood products (e.g., cross-laminated timber (CLT)), high-strength thermoplastics (e.g., polycarbonate, polyether ether ketone (PEEK)).

The modular grow tower assembly 100 may further comprise a plurality of lowering lift mechanisms 400A-400D (collectively referred to as 400) confined within the lift frames 200 located at the first end 102 and the second end 104 of the modular grow tower assembly 100. In some embodiments, each of the lift frames 200A, 200B, 200C, 200D may include one lowering lift mechanism 400A, 400B, 400C, 400D. As described in more detail herein, the carts 300 enter each lift frame 200 and are lowered in a vertical direction by the lowering lift mechanisms 400 such that the carts 300 are moved to a lower position within each row 114.

In various embodiments, the lift mechanisms 400 may be powered via pneumatic arms and/or motors, such as a plurality of translating mechanisms positioned along a length of a track, where each translating mechanism has a plurality of motorized apparatuses (e.g., motors) configured to push or pull the carts in a longitudinal direction. Correspondingly, the motorized apparatuses may be configured to push and retrieve the carts using extendable and retractable mechanical mechanisms to move the carts a predetermined length. In various embodiments, such motorized apparatus may be comprise one or more of motors, belts, chains, rollers, tracks, conveyers, rack and pinion gears, hydraulic systems, pneumatic systems, linear actuators, screw jacks, winches, cables and pulleys, gear systems, cam mechanisms, scissor lifts, and/or magnetic levitation systems.

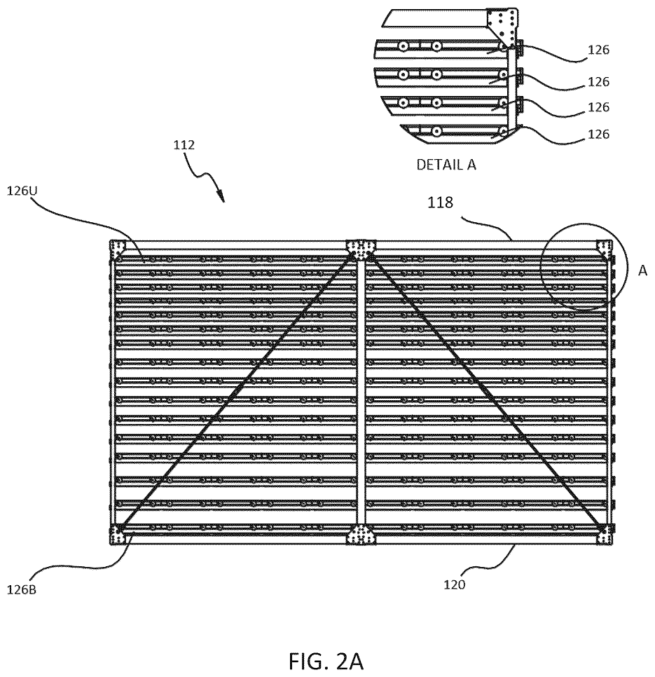

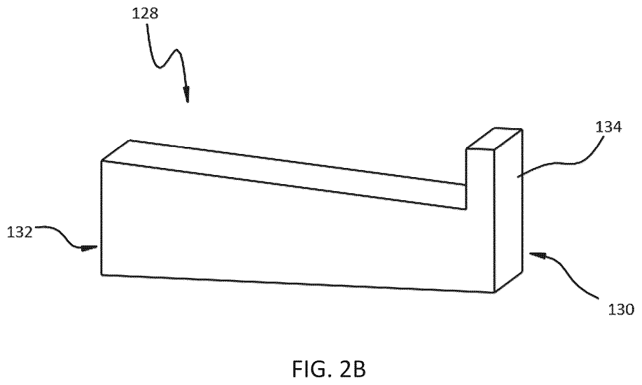

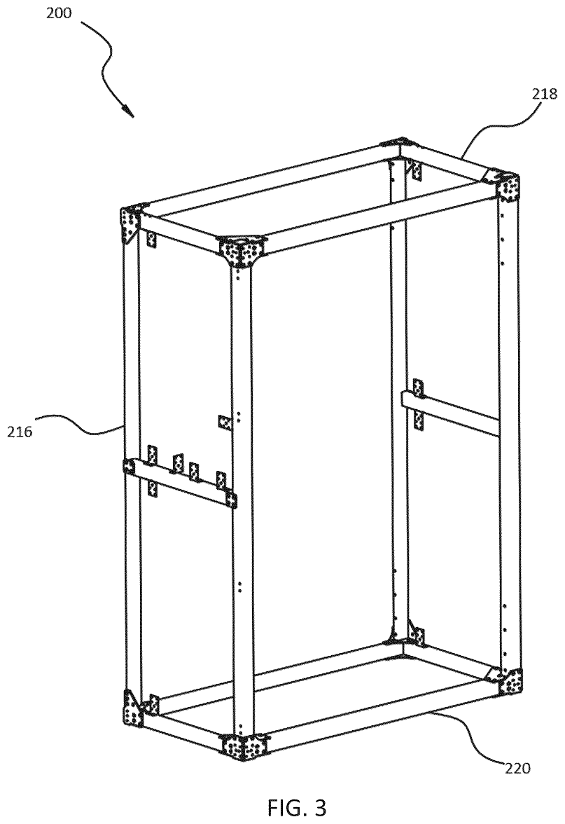

Turning now to FIG. 2A, each body frame 112 may include a plurality of subframe supports 126. The subframe supports 126 may be arranged in parallel in a vertical direction between a top side 118 and a bottom side 120 opposite the top side 118 of the body frame 112. The subframe supports 126 may be configured to hold the carts 300 as the carts traverse the modular grow tower assembly 100. In some embodiments, each subframe support 126 may be configured to hold six carts at a time. The subframe supports 126 may be spaced in a vertical direction such that the crops in the carts 300 have sufficient room to grow. As illustrated in FIG. 3, in one embodiment, the body frame 112 comprises 16 subframe supports. In this configuration, each body frame 112 may be capable of holding up to 96 carts at a time.

As further illustrated in FIG. 2A, each body frame may include an uppermost subframe support 126U and a bottommost subframe support 126B. As the carts 300 traverse the modular grow tower assembly 100, the carts 300 may move from the uppermost subframe support 126U to the bottommost subframe support 126B by following a moving path.

In various embodiments, the moving path may take various shapes. For example, the moving path may comprise a serpentine path, such as one that starts from the top, moving trays horizontally in one direction, then down one sequential row as they reach the end of the horizontal path. The trays then move in the opposite horizontal direction along the new row, then down another row to continue the same pattern, and so forth. Alternatively, in various embodiments, the moving path may comprise a C-Shape path, such that carts may move horizontally in one direction on the top half of the total rows, then down to the bottom half of the total rows where the lighting system may be located. The carts may then move horizontally in the opposite direction, being harvested at the bottom. Correspondingly, in some embodiments, the moving path may comprise alternating rows/skipping rows path such that carts may move from row A to row C and then, subsequently, carts may move from row B to row D, instead of A to B to C to D in sequence. Further, in various embodiments, the moving path may having batching collections of rows such that groups of rows may be set and left without movement for many days and then all moved to a new set of rows with different heights or systems in one rapid succession. For example, rows A, B, C, and D may be batched to be moved on the same day to rows I, J, K, and L, while rows E, F, G, and H remain stationary until the following day. Additionally, in various embodiments, the moving path may comprise a haphazard path such that carts from the top rows can be moved down to any of the lower rows where different systems such as nutrients, lighting, watering, and measuring are located, and then moved back up again to the same row of origin or another row, offering full versatility.

Turning now to FIG. 3, each lift frame 200 may include an enclosure 216 defining a top end 218, a bottom end 220 opposite the top end 218, and a lowering lift mechanism 400 that translates between the top end 218 and the bottom end 220. As discussed in more detail herein, the lowering lift mechanism 400 operates to move carts 300 in a vertical direction to a different subframe support 126 within each body frame 112. The lowering lift mechanism 400 may include any suitable device for moving the carts 300 in the vertical direction such as rollers, tracks, rack and pinion gears, and the like. As described in more detail herein, the carts 300 enter a lift frame 200 and are lowered in the vertical direction by the lowering lift mechanism 400 such that the carts 300 are moved to a lower subframe support 126 within each body frame 112.

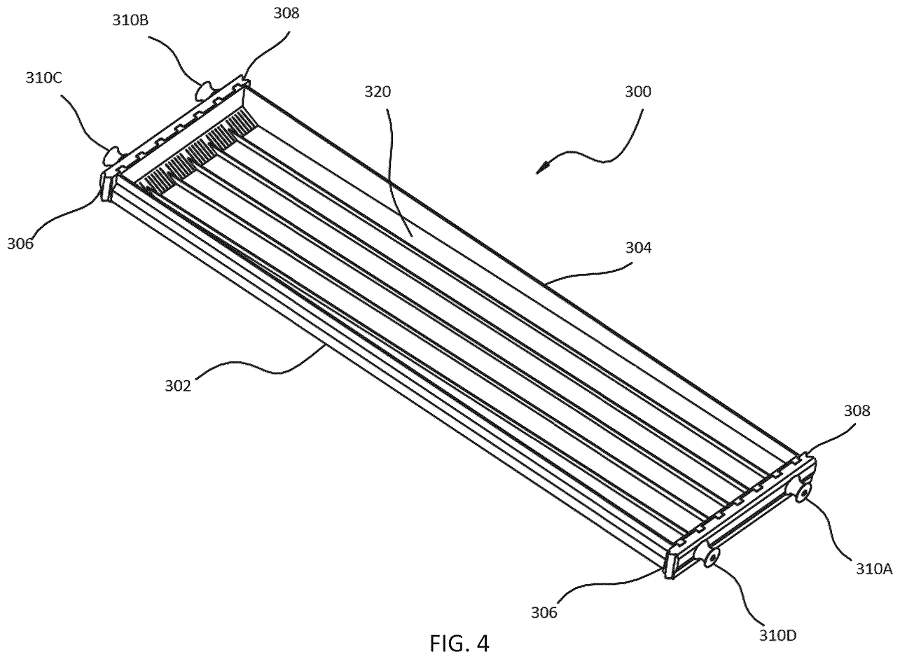

One embodiment of the cart 300 is illustrated in FIG. 4. The cart 300 may support a quantity of crop material and include a plurality of wheels 310A, 310B, 310C, and 310D (collectively referred to as 310) for supporting the crop material as the carts 300 traverse the moving path (e.g., serpentine moving path) of the modular grow tower assembly 100. The cart 300 may additionally include a tray 320, such as a foam reinforced thermoformed tray, that holds the crop material and/or microgreens.

Referring still to FIG. 4, the cart 300 may include a first end 302 and a second end 304. In some embodiments, the first end 302 and second end 304 may each include an engagement mechanism which is configured to allow the cart 300 to engage with other carts 300. For example, the first end 302 of the cart 300 may include at least one male engagement mechanism 306 and the second end of the cart 300 may include at least one female engagement mechanism 308. The male engagement mechanism 306 may be configured to engage the female engagement mechanism 308 of an adjacent cart 300, such that each of the plurality of carts 300 may remain in contact as the carts 300 traverse the moving path of the modular grow tower assembly 100.

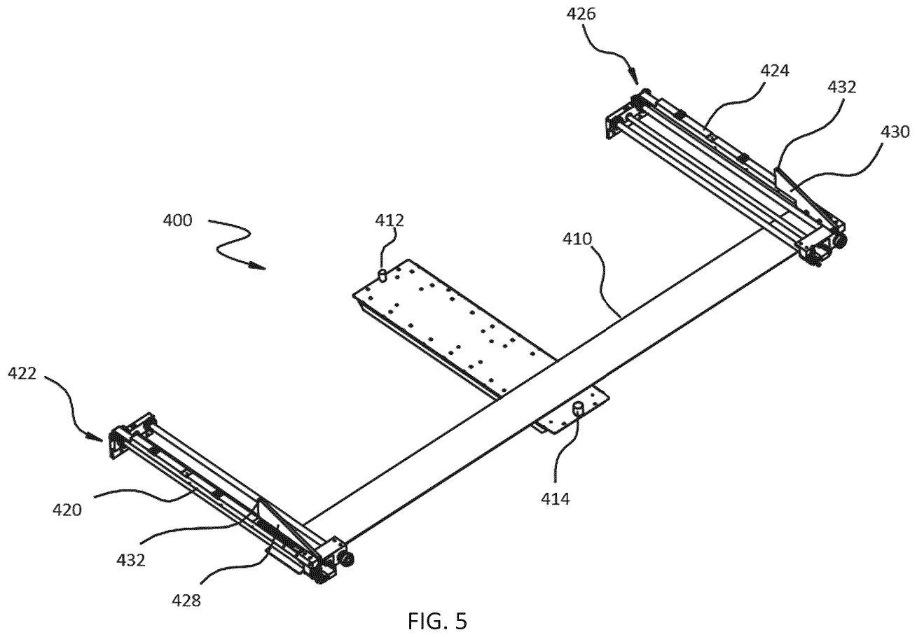

FIG. 5 illustrates the lowering lift mechanism 400, which may include a receiving plate 410 for engaging with the carts 300. The receiving plate 410 may further include a first arm 420 located on a first end 422 of the receiving plate 410, and a second arm 424 located on a second end 426 of the receiving plate 410 opposite the first end 422. Additionally, the first arm 420 may include a first receiving block 428, and the second arm may include second receiving block 430. The first and second receiving blocks 428, 430 may include a notches 432 which may be configured to engage the male engagement mechanism 306 and female engagement mechanism 308 of the carts 300.

The receiving plate 410 may be configured such that the receiving plate 410 may be actuated in a longitudinal direction between an extended position 412 and a retracted position 414. In the retracted position 414, the entirety of the receiving plate 410 may remain within its respective lift frame 200. In the extended position 412, the first and second arms 420, 424 may extend outside the lift frame 200 and into the subframe supports 126 of one of the body frames 112. In the extended position 412, the first and second arms 420, 424 may be configured to slide beneath the wheels 310 of the carts 300, and the notches 432 of the first and second receiving blocks, 428, 430 may be configured to engage the male and female engagement mechanisms 306, 308, of the carts 300.

In some embodiments at least a portion of the subframe supports 126 may include support stops 128, as illustrated in FIG. 2B. The support stops 128 may be located at the end of each subframe support 126. The support stops 128 may include a distal end 130 which is adjacent to the lift frame 200, and a proximal end 132 located opposite the distal end 130. The distal end 130 may include a bumper 134, which may be configured to stop the motion of the carts 300 by stopping the wheels 310 of the cart. In some embodiments, the proximal end 132 may have a downward slope, such that carts 300 which reach the proximal end 132 of the support stop 128 will continue to roll across the support stop 128 until the wheels 310 of the cart 300 hit the bumper 134. Due to the presence of the support stops 128, when the receiving plate 410 has engaged the cart 300, the lowering lift mechanism 400 must lift the cart 300 above the bumper 134 prior to returning to the retracted position 414. As the lowering lift mechanism 400 raises the cart 300, the cart 300 may disengage from its adjacent cart 300 such that it may be pulled from the subframe support 126 on which it is located.

Once the cart 300 has been raised above the bumper 134, the cart 300 may be pulled from the subframe support 126 on which it is located and into the lift frame 200 by returning the receiving plate 410 to the retracted position 414. It should be noted that the receiving plate 410 may be actuated by any mechanism capable of actuating the receiving plate 410 between the extended position 412 and the retracted position 414, such as a motor, driver, actuator, or the like. Once the receiving plate 410 is returned to the retracted position 414 and the cart 300 is pulled into the lift frame 200, the lowering lift mechanism 400 may be configured to lower the cart 300 in a vertical direction such that the cart 300 is aligned with the subframe support 126 which is directly beneath the subframe support 126 from which the cart 300 was obtained. When the lowering lift mechanism has been lowered to align with the lower subframe support 126, the receiving plate 410 may be actuated to the extended position 412, thereby pushing the cart 300 out of the lift frame 200 and back onto the subframe support 126 of the body frame 112.

As the cart 300 is pushed onto the subframe support 126, the male and/or female engagement mechanism 306, 308 will engage with the male and/or female engagement mechanism 306, 308 of the adjacent cart 300 on the subframe support 126. As the cart 300 engages its adjacent cart 300, each of the carts 300 located on the subframe support 126 may be pushed towards the opposite lift frame 200.

In some embodiments, the plurality of lowering lift mechanisms 400 are configured such that the movements of the lowering lift mechanisms 400 are synchronized. In this configuration, the lowering lift mechanism 400 may always pull a cart 300 from a given subframe support 126 of the body frame 112 before the lowering lift mechanism 400 located in the opposite lift frame 200 pushes a cart 300 onto the subframe support 126. By synchronizing the plurality of lowering lift mechanisms 400 such that a cart 300 is pulled from the subframe support 126 prior to a cart 300 being pushed onto the subframe support 126, it is possible to ensure that none of the plurality of carts 300 are pushed into the lift frames 200 when no lowering lift mechanism 400 is present.

Referring again to FIG. 1, the manner in which the carts 300 traverse the moving path of the modular grow tower assembly 100 includes the lowering lift mechanism 400B pulling a cart 300 from the uppermost subframe support 126U of the body frame 112B, such that the uppermost subframe support 126U may be capable of receiving a new cart. Once the lowering lift mechanism 400B has pulled the cart 300 into the lift frame 200B, the lowering lift mechanism 400A may introduce a new cart 300 onto the uppermost subframe support 126U of body frame 112A. In the embodiment illustrated in FIG. 1, new carts 300 may enter the modular grow tower assembly 100 by being pushed onto the uppermost subframe support 126U of body frame 112A at a first end 102 of the modular grow tower assembly 100.

As the receiving plate 410 of the lowering lift mechanism 400A extends, the male engagement mechanism 306 of the cart 300 may engage the female engagement mechanism 308 of the adjacent cart 300 located on the uppermost subframe support 126U of the body frame 112A. Once the new cart 300 has engaged the adjacent cart 300, each of the carts 300 will be pushed in a longitudinal direction towards the opposite lift frame 200B as the receiving plate 410 continues to extend. When the receiving plate 410 has achieved the extended position 412, the new cart 300 may be secured on the uppermost subframe support 126U of body frame 112A, such that each of the carts 300 located on the uppermost subframe support 126U of body frame 112A will have moved the length of one cart 300 towards the opposing lift frame 200B. Similarly, the carts 300 positioned in body frame 112A may push the remaining carts in body frame 112B such that the carts 300 in body frame 112B will have moved the length of one cart 300 towards the opposing lift frame 200B. As the carts 300 positioned on the uppermost subframe support 126U of body frame 112A push the carts 300 positioned on the uppermost subframe support 126U of body frame 112B, one cart 300 may transition from body frame 112A to body frame 112B, such that the uppermost subframe support 126U of body frame 112A and body frame 112B may contain the same number of carts 300.

After the lowering lift mechanism 400A has pushed its cart 300 onto the uppermost subframe support 126 of the body frame 112A, the lowering lift mechanism 400A may be lowered in a vertical direction through the lift frame 200A such that the lowering lift mechanism 400A aligns with the subframe support 126 located below the uppermost subframe support 126U of the body frame 112A. Once the lowering lift mechanism 400A is aligned, the lowering lift mechanism 400A may extend to the extended position 412 and engage the cart 300 located on the first end 102 of the subframe support 126 of body frame 112A. The lowering lift mechanism 400A may then raise the cart 300 above the bumper 134 of the support stop 128 of the subframe support 126, and retract to the retracted position 414, thereby pulling the cart 300 from the body frame 112A and into the lift frame 200A.

Once the cart 300 is secured on the lowering lift mechanism 400A inside the lift frame 200A, the lowering lift mechanism 400B may be lowered in a vertical direction through lift frame 200B such that the lowering lift mechanism 400B aligns with the subframe support 126 located below the uppermost subframe support 126U at the second end 104 of the body frame 112B. Once the lowering lift mechanism 400B is aligned, the lowering lift mechanism 400B, which holds the cart 300 retrieved from the uppermost subframe support 126U in body frame 112B, may push the cart onto the subframe support 126. As the lowering lift mechanism 400B pushes its cart 300 onto the subframe support 126, the female engagement mechanism 308 of the cart 300 may engage the male engagement mechanism 306 of the adjacent cart 300 located on the subframe support 126 of the body frame 112B, such that each of the carts 300 located on the subframe support are pushed towards the opposite lift frame 200A.

This process may be repeated until the plurality of carts 300 have traversed each of the subframe supports 126 of the body frames 112 in row 114A. Once a cart 300 has traversed the entire serpentine moving path of the row 114A, the cart may be located on the bottommost subframe support 126B at a position corresponding to the first end 102 of the body frame 112A.

In order for the cart 300 to transition from row 114A to row 114B, the lowering lift mechanism 400C may be configured such that it is capable of being raised into the lift frame 200A. In this embodiment, the lowering mechanism 400C may be raised into lift frame 200A in order to engage the cart 300 located at the first end 102 of the bottommost subframe support 126 of the body frame 112A.

Once the lowering mechanism 400C has engaged the cart 300 located on the bottommost subframe support 126B of body frame 112A on the first end 102, it may be pulled into lift frame 200A, and lowered into lift frame 200C. The cart 300 may be lowered into lift frame 200C such that the cart 300 aligns with the uppermost subframe support 126U of body frame 112C at a first end 102. At this point, lowering lift mechanism 400D may pull a cart 300 from the second end 104 of the uppermost subframe support 126U of body frame 112d in order to create space on the subframe support 126U for the cart 300 which has been retrieved from the bottommost subframe support 126B of body frame 112A.

Once the cart 300 is secured within lift frame 200D, the cart 300 retrieved from the bottommost subframe support 126B of body frame 112A may then be pushed onto the uppermost subframe support 126 of the body frame 112C in order to begin traversing the serpentine moving path of row 114B. The carts 300 may continue to traverse the moving path until each of the plurality of carts 300 arrives at the first end 102 of the bottommost subframe support 126B of body frame 112A, which may be the point in the modular grow tower assembly 100 where the moving path terminates. Once a cart 300 reaches the termination point, the cart 300 may be removed from the modular grow tower assembly 100 such that the crops grown within the tray 320 of the cart 300 may be harvested. Once the crops have been harvested, the cart 300 may be sanitized, seeded with new crop starting material, and returned to the modular grow tower assembly 100 to traverse the moving path (e.g., a serpentine moving path) again.

As discussed previously, the motion of carts does not need to follow a serpentine path nor is it limited to one set sequence. One possible method of moving carts in a modular grow tower assembly may be alternating which row carts are moved to, in a non-sequential or non-serpentine path. This alternating method only moves carts when necessary, to designated new rows of the modular grow tower assembly, based on specific growing requirements such as crop height, row spacing, lighting elements, nutrient application systems, visual inspections, harvesting, and/or washing. This method optimizes the movement of carts by reducing the overall motion required and consequently minimizing wear on the carts and the need for an extensive motion system.

In various embodiments, the alternating rows method is controlled by a computer program executed by the master controller that dictates the sequence of cart movements based on specific growing requirements. For instance, the system can start by moving a cart from the top row to row A, and in the next cycle, move another cart from the top row to row B. This sequence can be customized to suit various growing conditions, ensuring that carts are moved efficiently and only when necessary.

Such a method allows for grouping certain rows together and alternating the movement of these groups. For example, the system can alternate between moving carts in rows A, C, and E in one cycle and rows B, D, and F in the next cycle. Another possibility is moving carts from row A to C in one cycle, then only move carts from rows B to D in the next. Another possibility is moving carts from rows A, B, and C to the next level of rows D, E, and F or even to the bottom rows, for the sake of example could be labeled X, Y, and Z. This reduces the overall motion required during an entire grow cycle of a crop from start to finish, thereby lowering the wear on the carts and minimizing the demand on the lift mechanisms.

Another option, in various embodiments, is allowing different rows of carts to be consolidated together into one entirely new row, and another possibility is individual carts can alternately be sent to a different row during a movement cycle. This is particularly useful when rows are spaced at different heights, and therefore accommodate continually growing crops. Another possible benefit is minimizing the cost of lighting systems by only requiring lighting on one or two rows. There are many other reasons to justify providing flexibility of cart paths and allowing consolidating rows. Accordingly, alternating and shuffling carts and rows can be performed in a large variety of ways in accordance with the present disclosure.

In various embodiments, the non-sequential movement of the carts is controlled by a computer program executed by the master controller, which dictates the cart movement sequence based on the specific growing requirements. This sequence can be customized in other variations to suit various growing conditions, grow times of different crops, reducing the frequency of cart movements and enhancing system efficiency. Correspondingly, a cart tracking system of sensors can allow the master controller to keep track of the location of each cart and monitor the growing properties of the crops inside each cart. In various embodiments, the master controller can also be configured to allow users to test and predict different patterns of cart movements to discover optimal cart pathways and patterns.

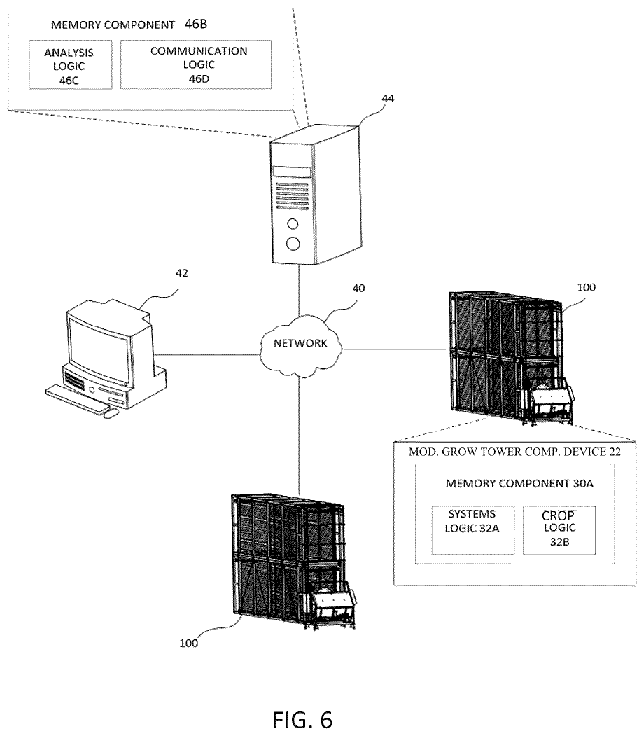

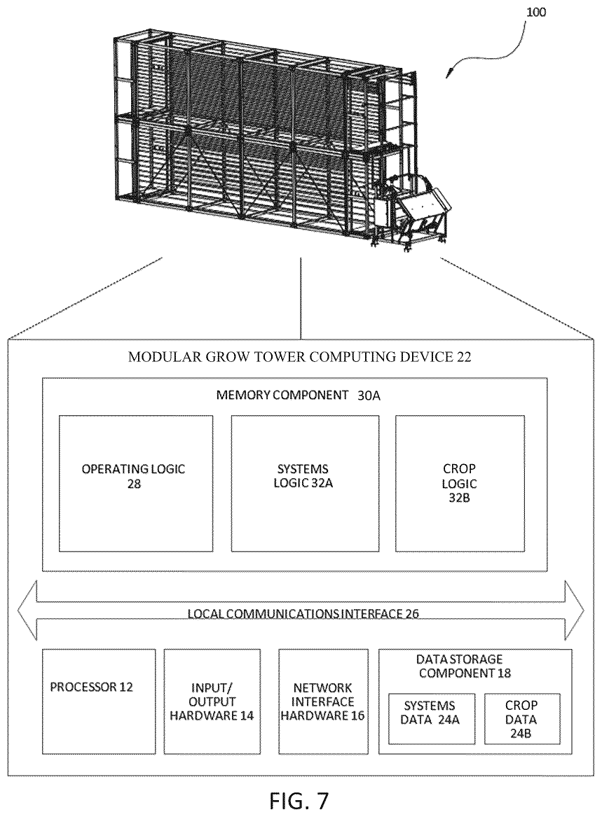

Turning now to FIGS. 6 and 7, a computing environment for providing a modular grow tower assembly 100, may also be provided. As described above, the modular grow tower assembly 100 may include a master controller, which may be provided by the modular grow tower computing device 22. The modular grow tower computing device 22 may include a memory component 30A, which stores systems logic 32A and crop logic 32B. The systems logic 32A may monitor and control operations of one or more of the components of the modular grow tower assembly 100; may provide one or more user interfaces; and/or may otherwise cause the modular grow tower assembly 100 to perform the functionality provided herein. As an example, the systems logic 32A may cause actuation of one or more hardware components of the modular grow tower assembly 100; receive and/or determine updates, upgrades, or adjustments to current grow recipes; receive new grow recipes, and/or otherwise control operations of the modular grow tower assembly 100. The crop logic 32B may be configured to determine crop growth and may facilitate implementation of the grow recipe via the systems logic 32A.

In various embodiments, the tower computing device 22 (e.g., master controller device) or other component of the computing environment can monitor and measure sensor data, growth parameters, or other environmental factors, such as, but not limited to, temperature, humidity, light intensity, light duration, light spectrum, water quality/purity, water quantity, watering frequency, water temperature, water polarization, water flow rate, water filtration system efficiency, water mineral content, nutrient concentration, nutrient composition, pH level, airflow, CO2 concentration, soil type, soil moisture, soil pH, soil composition, tray size and shape, tray material, growth medium, plant density, genetic factors, pollination, growth stage, harvest timing, microbial activity, oxygen levels, feeding frequency (for insects and larvae), substrate type (for fungus), light-dark cycles, movement frequency, sound vibrations, structural support (stakes, netting, cages, trellis, etc.), climatic conditions, altitude/barometric pressure, cleaning/washing/sanitizing/hygiene practices, growth hormones, symbiotic relationships if different crops are mixed, different crop or seed varieties in one tray, amount of human contact, pre-planting treatments or coatings applied to seeds, crop harvest weight, crop color, crop uniformity, crop density, crop level, nutrient content of crop harvests, and/or elemental analysis of crop harvests.

Additional factors that can be measured and/or used to customize tower operations include cart paths, cart maintenance reports, total electricity use, total water use, total seed or crop-starting material amount or weight, total time of carts in motion, total downtime of no motion, maintenance history, usage history, change history, video monitoring of individual systems, video monitoring of facility, user logs, software update history, bug reports, weather, and/or user notes.

Additionally, the modular grow tower assembly 100 may be coupled to a network 40. The network 40 may include the internet or other wide area network, a local network, such as a local area network, a near field network, and/or a peer-to-peer network, such as via Bluetooth or a near field communication (NFC) network. The network 40 is also coupled to a user computing device 42, a remote computing device 44, and/or another modular grow tower assembly 100 having a modular grow tower computing device, similar to the modular grow tower computing device 22. The user computing device 42 may be configured as a personal computer, laptop, mobile device, tablet, server, etc. and may be utilized as an interface through which a user may interact with one or more devices depicted in FIG. 1. In some embodiments, the remote computing device 44 may send a grow recipe to the modular grow tower computing device 22 for implementation by the modular grow tower assembly 100. The modular grow tower assembly 100 may then send notification to a user of the user computing device 42.

The remote computing device 44 may be configured as a server, personal computer, tablet, mobile device, etc. and may be utilized for machine to machine communications. Accordingly, the remote computing device 44 may include a memory component 46B. The memory component 46B may store analysis logic 46C and communication logic 46D. The analysis logic 46c may be configured to receive a grow recipe, determine updates, upgrades, and/or adjustments to a grow recipe and determine differences between the grow recipe received and the current grow recipe that is stored by the remote computing device 44. The remote computing device 44 may alter a stored grow recipe and/or save the received grow recipe for communicating the update, upgrade or adjustment to another modular grow tower assembly 100 via the communication logic 46D.

FIG. 7 depicts a modular grow tower computing device 22, according to embodiments described herein. As discussed above, the modular grow tower computing device 22 includes a memory component 30A, a processor 12, input/output hardware 14, network interface hardware 16, and a data storage component 18 (which stores systems data 24A, crop data 24B, and/or other data). Each of the components of the modular grow tower computing device 22 may be communicatively coupled to a local communications interface 26. The local communications interface 26 is generally not limited by the present disclosure and may be implemented as a bus or other communications interface to facilitate communication among the components of the modular grow tower computing device (e.g., master controller device) coupled thereto.

The memory component 30A may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), Blu-Ray discs, and/or other types of non-transitory computer-readable mediums. Depending on the particular embodiment, these non-transitory computer-readable mediums may reside within or outside the modular grow tower computing device 22. The memory component 30A may store, for example, operating logic 28, the systems logic 32A, and the crop logic 32B. The operating logic 28, the systems logic 32A and the crop logic 32B may each include a plurality of different pieces of logic, each of which may be embodied as a computer program, firmware, and/or hardware, as an example.

The operating logic 28 may include an operating system and/or other software for managing components of the modular grow tower computing device 22. As discussed above, the systems logic 32A and the crop logic 32B may reside in the memory component 30A and may be configured to perform the functionality, as described above. In some embodiments, the systems logic 32A and the crop logic 32B may reside on different computing devices. As an example, one or more of the functionalities and/or components described herein may be provided by the user computing device 42 and/or remote computing device 44. While the modular grow tower computing device 22 is illustrated with the systems logic 32A and the crop logic 32B as separate logical components, this is only an example. In some embodiments, a single piece of logic (and/or or several linked modules) may cause the modular grow tower computing device 22 to provide the described functionality.

The processor 12 may include any processing component operable to receive and execute instructions (such as from the data storage component 18 and/or the memory component 30A). Illustrative examples of the processor 12 include, but are not limited to, a computer processing unit (CPU), a many integrated core (MIC) processing device, an accelerated processing unit (APU), a digital signal processor (DSP). In some embodiments, the processor 12 may be a plurality of components that function together to provide processing capabilities, such as integrated circuits (including field programmable gate arrays (FPGA)) and the like.

The input/output hardware 14 may include and/or be configured to interface with microphones, speakers, a display, and/or other hardware. That is, the input/output hardware 14 may interface with hardware that provides a user interface or the like. For example, a user interface may be provided to a user for the purposes of adjusting settings, viewing a status, and the like. The user interface may further comprise graphical elements such as buttons, menus, display graphs, and other similar components to enhance usability.

The network interface hardware 16 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the modular grow tower computing device 22 and other computing devices, such as the user computing device 42, the remote computing device 44, and/or other devices.

The data storage component 18 may generally be any medium that stores digital data, such as, for example, a hard disk drive, a solid state drive (SSD), a compact disc (CD), a digital versatile disc (DVD), a Blu-Ray disc, and/or the like. It should be understood that the data storage component 18 may reside local to and/or remote from the modular grow tower computing device 22 and may be configured to store one or more pieces of data and selectively provide access to the one or more pieces of data.

It should be understood that while the components in FIG. 7 are illustrated as residing within the modular grow tower computing device 22, this is merely an example. In some embodiments, one or more of the components may reside external to the modular grow tower computing device 22. It should also be understood that, while the modular grow tower computing device 22 is illustrated as a single device, this is also merely an example. That is, the modular grow tower computing device 22 may represent a plurality of devices that are communicatively coupled to one another and provide the functionality described herein.

Additionally, while the modular grow tower computing device 22 is illustrated with the various logic components (e.g., the operating logic 28, the systems logic 32A, and the crop logic 32B) and data components (e.g., the systems data 24A and the crop data 24B) as separate components, this is also an example. In some embodiments, a single piece of logic (and/or a plurality of linked modules) and/or a single data component (and/or a plurality of linked modules) may also cause the modular grow tower computing device 22 to provide the functionality described herein.

Similarly, while the modular grow tower computing device 22 is depicted in a “PC” environment, it should be understood that at least some embodiments may not be limited in this way. Specifically, some embodiments may be configured such that the modular grow tower computing device 22 is configured as and/or includes a programmable logic controller (PLC) and/or other computing infrastructure. To the extent that the modular grow tower assembly 100 utilizes a PLC, appropriate equivalents of the components described with reference to FIGS. 6 and 7 may be utilized.

From the above, it is to be appreciated that defined herein is a system and method for lowering carts in a modular grow tower, including a plurality of lowering lift mechanisms configured to pull carts from a plurality of body frames, lower the plurality of carts, and push the plurality of carts back onto the body frames at a lower position.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A system for lowering a cart in a modular grow tower assembly, the system comprising:
a plurality of body frames, each having multiple subframe supports arranged in parallel in a vertical direction;
a plurality of lift frames positioned at opposite ends of the body frames;
a plurality of carts, each cart comprising at least one of the following features:
a plurality of wheels for traversing the subframe supports;
a tray to support growing of crop material; or
an engagement mechanism such that the carts remain in contact with adjacent carts as they traverse the subframe supports and become disengaged when the cart is moved vertically by a lowering lift mechanism; and
a plurality of lowering lift mechanisms confined within the lift frames, each configured to pull one of the carts from a subframe support, lower the cart to a new subframe support, and push the cart onto the new subframe support, facilitating movement of the carts through the modular grow tower assembly.

2. The system of claim 1, wherein the carts move in serpentine movement through the modular grow tower assembly.

3. The system of claim 1, wherein the body frames and lift frames are connected using a fastening mechanisms and are configured or rearranged to adjust a size of the modular grow tower assembly.

4. The system of claim 1, wherein each cart includes wheels for supporting a cart.

5. The system of claim 1, wherein the engagement mechanism comprises a notch for secure engagement with a corresponding engagement mechanism of an adjacent cart.

6. The system of claim 1, further comprising support stops located at the ends of the subframe supports, each support stop including a bumper to stop motion of the carts.

7. The system of claim 1, further comprising a computing environment to monitor and control operations of the modular grow tower assembly, including a tower computing device configured to execute system synchronization and crop logic for managing the movement of carts and crop growth conditions.

8. The system of claim 7, wherein the tower computing device is configured to control operation of the body frames, lift frames, and carts.

9. A method for lowering a cart in a modular grow tower assembly, the method comprising:
providing a modular grow tower assembly including a plurality of body frames and a plurality of lift frames, where each body frame includes multiple subframe supports arranged in parallel in a vertical direction;
configuring a plurality of carts to traverse the subframe supports, each cart having a first end with at least one male engagement mechanism and a second end with at least one female engagement mechanism; and
utilizing a plurality of lowering lift mechanisms within the lift frames to pull carts from the subframe supports of the body frames, lower the carts, and push the carts onto lower subframe supports.

10. The method of claim 9, wherein the lowering lift mechanisms are synchronized to ensure that a cart is pulled from a subframe support before another cart is pushed onto the same subframe support.

11. The method of claim 9, further comprising raising the cart above a bumper located at the end of each subframe support before pulling the cart into the lift frame.

12. The method of claim 9, further comprising introducing new carts onto the uppermost subframe support of a top row, pushing existing carts in a longitudinal direction through the body frames, and repeating the lowering process until the carts traverse in a serpentine path to a bottommost subframe support of a bottom row.

13. The method of claim 9, further comprising sanitizing and seeding the carts with new crop material after harvesting.

14. The method of claim 9, further comprising receiving, by a tower computing device, grow recipes from a remote computing device and adjusting operation of the modular grow tower assembly accordingly.

15. A lowering lift mechanism for lowering a cart in a modular grow tower assembly, the lowering lift mechanism comprising:
a receiving plate for engaging with the cart, including first and second arms located at opposite ends of the receiving plate;
first and second receiving blocks located on the first and second arms, respectively, each receiving block including notches configured to engage male and female engagement mechanisms on the cart;
an actuator configured to move the receiving plate between an extended position, where the first and second arms extend into subframe supports to engage the cart, and a retracted position, where the plate is within the lift frame; and
a lifting mechanism configured to raise the cart above a bumper on the subframe support before pulling the cart into the lift frame and lowering the cart to align with a lower subframe support, then extending the receiving plate to push the cart onto the new subframe support.
